(19) United States
(12) Patent Application Publication
(10) Pub. No.: US 2018/0137733 A1
(43) Pub. Date: May 17, 2018

(54) USER LOCATION NOTIFICATION SYSTEM AND METHOD THEREOF

(71) Applicant: Aengin Technology Inc., Taipei City (TW)

(72) Inventors: Yi-Cheng Yang, Taipei City (TW); Yi-Hsiang Chen, Taipei City (TW)

(73) Assignee: Aengin Technology Inc., Taipei City (TW)

(21) Appl. No.: 15/814,401

(22) Filed: Nov. 16, 2017

Related U.S. Application Data
(60) Provisional application No. 62/423,161, filed on Nov. 16, 2016.

(30) Foreign Application Priority Data
Sep. 11, 2017 (TW) 106131065

(51) Int. Cl. G08B 21/02

(52) U.S. Cl. CPC G08B 21/0272; H04L 67/18; G08B 21/0252

(57) ABSTRACT

A user location notification system and a method thereof are provided. The system includes: a first signal transmitting device, a first sensing device, a second sensing device, and a server. The first sensing device and the second sensing device are deployed in a first place. The first signal transmitting device transmits a first signal related to a first user. The first sensing device detects the first signal and transmits a first message according to the first signal. The second sensing device detects the first signal and transmits a second message according to the first signal. The server receives the first message and the second message and sends a first notification message to a first electronic device according to the first message and the second message, wherein the first notification message indicates that the first user is at a specific location in the first place.

### CROSS-REFERENCE TO RELATED APPLICATION

This application claims the priority benefits of U.S. provisional application Ser. No. 62/423,161, filed on Nov. 16, 2016, and Taiwan application serial no. 106131065, filed on Sep. 11, 2017. The entirety of each of the above-mentioned patent applications is hereby incorporated by reference herein and made a part of this specification.

### BACKGROUND OF THE INVENTION

### Field of the Invention

The invention relates to a user location notification system.

### Description of Related Art

Thanks to medical progress, people live longer nowadays. Therefore, the care of the elderly has become one of today's important issues. Usually, people would want to know the whereabouts of their elderly parents, so that they can react immediately in the event of a sudden situation. However, currently there is no effective system for accurate indoor positioning.

### SUMMARY OF THE INVENTION

In view of the above, the invention provides a user location notification system and a user location notification method. The system makes it possible to effectively position a user that is being monitored (e.g., the elderly) indoors and instantly transmit a message indicating a specific location of the monitored user in the indoor space back to an electronic device of another user (e.g., children or social workers). Thus, the system is capable of achieving accurate positioning and real-time monitoring.

The invention provides a user location notification system, which includes: a first signal transmitting device, a first sensing device, a second sensing device, and a server. The first sensing device and the second sensing device are disposed in a first place. The first signal transmitting device transmits a first signal related to a first user. The first sensing device detects the first signal and transmits a first message according to the first signal. The second sensing device detects the first signal and transmits a second message according to the first signal. The server receives the first message and the second message and transmits a first notification message to a first electronic device according to the first message and the second message, wherein the first notification message indicates that the first user is at a specific location in the first place.

The invention provides a user location notification method adapted for a user location notification system. The system includes: a first signal transmitting device, a first sensing device, a second sensing device, and a server, wherein the first sensing device and the second sensing device are disposed in a first place. The method includes: transmitting a first signal related to a first user by the first signal transmitting device; detecting the first signal and transmitting a first message according to the first signal by the first sensing device; detecting the first signal and transmitting a second message according to the first signal by the second sensing device; and receiving the first message and the second message and transmitting a first notification message to a first electronic device according to the first message and the second message by the server, wherein the first notification message indicates that the first user is at a specific location in the first place.

Based on the above, the user location notification system and the user location notification method provided by the invention make it possible to effectively position the user that is being monitored (e.g., the elderly) indoors and instantly transmit the message indicating the specific location of the monitored user in the indoor space back to the electronic device of another user (e.g., children or social workers). Thus, the system is capable of achieving accurate positioning and real-time monitoring.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic diagram of the user location notification system according to an embodiment of the invention.

FIG. 2A is a schematic diagram of the electronic device according to an embodiment of the invention.

FIG. 2B is a schematic diagram of the server according to an embodiment of the invention.

FIG. 2C is a schematic diagram of the signal transmitting device according to an embodiment of the invention.

FIG. 2D is a schematic diagram of the sensing device according to an embodiment of the invention.

FIG. 3A is a schematic diagram of application of the user location notification system according to an embodiment of the invention.

FIG. 3B is a schematic diagram showing detection of the user wearing the signal transmitting device who enters or leaves a place according to an embodiment of the invention.

FIG. 3C is a schematic diagram of application of the user location notification system according to another embodiment of the invention.

FIG. 4 is a schematic diagram of configuration of the sensing devices according to an embodiment of the invention.

FIG. 5 is a flowchart of the user location notification method according to an embodiment of the invention.

### DESCRIPTION OF THE EMBODIMENTS

Descriptions of the invention are given with reference to the exemplary embodiments illustrated by the figures. In addition, wherever possible, identical or similar reference numerals stand for identical or similar elements/components in the figures and the embodiments.

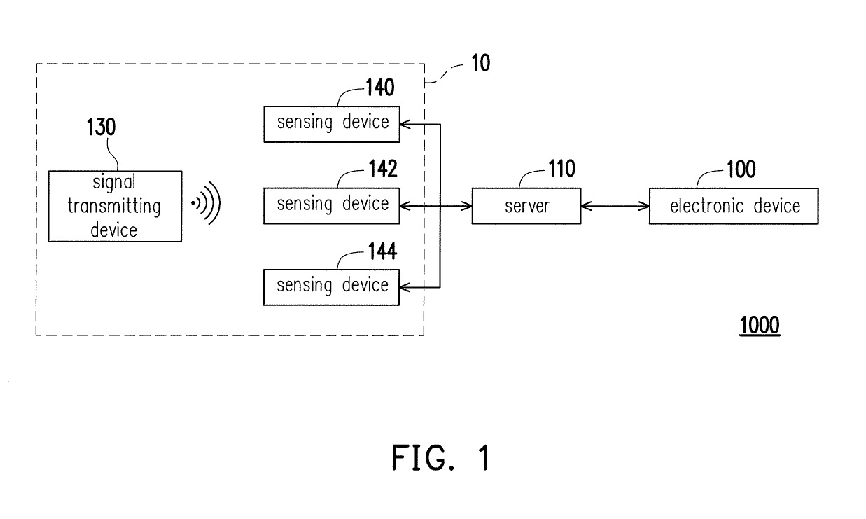

FIG. 1 is a schematic diagram of a user location notification system according to an embodiment of the invention.

Referring to FIG. 1, in this exemplary embodiment, a user location notification system 1000 includes an electronic device 100, a server 110, a signal transmitting device 130, a sensing device 140, a sensing device 142, and a sensing device 144. The electronic device 100 and the server 110 may communicate with each other via a wired or wireless network, and the sensing devices 140 to 144 and the server 110 may communicate with each other via a wired or wireless network. The sensing devices 140 to 144 are respectively disposed in a place 10 for detecting a signal transmitted by the signal transmitting device 130 in the place 10. The place 10 refers to an indoor place, such as a living room, a bathroom, a kitchen, an office, and so on, where the sensing devices 140 to 144 may be disposed. Moreover, the sensing devices 140 to 144 may be disposed at different locations in the place 10.

It should be noted that the disclosure is not intended to limit the numbers of the electronic devices, the servers, the sensing devices, and the signal transmitting devices in the user location notification system 1000 and the number of the places for disposing the sensing devices. Although FIG. 1 illustrates that only three sensing devices are disposed in the place 10, in other embodiments, more or fewer sensing devices may be disposed in the place 10.

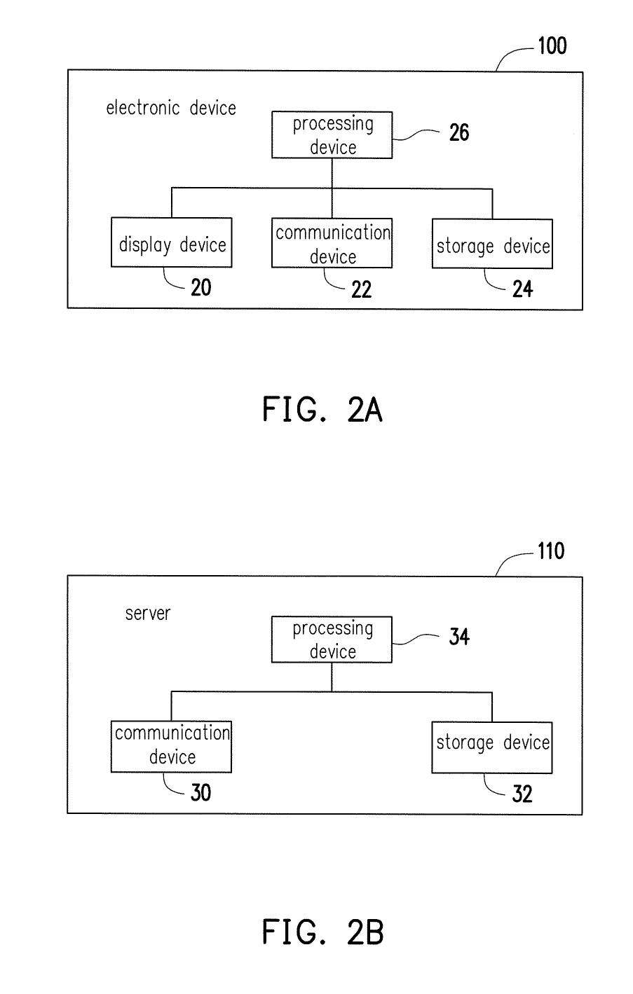

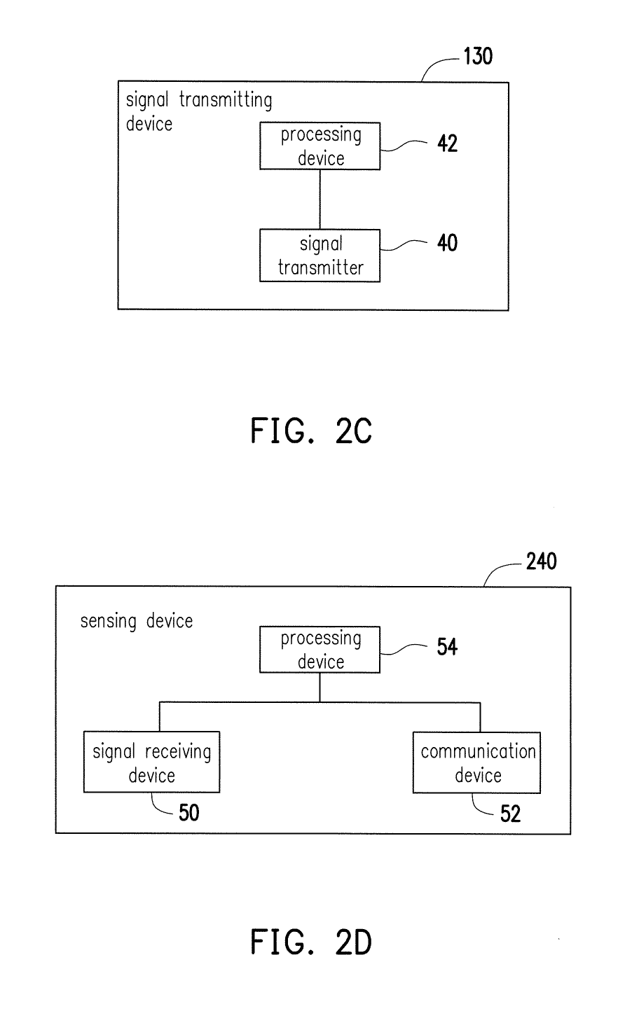

FIG. 2A is a schematic diagram of the electronic device according to an embodiment of the invention.

Referring to FIG. 2A, the electronic device 100 includes a display device 20, a communication device 22, a storage device 24, and a processing device 26. The display device 20, the communication device 22, and the storage device 24 are respectively coupled to the processing device 26. The electronic device 100 is a mobile electronic device, such as a mobile phone, a tablet computer, a laptop computer, and so on, but not limited thereto.

The display device 20 is configured to provide a display function in a display region of the electronic device 100. The display device 20 may be a device that provides the display function, such as a liquid crystal display (LCD), a light-emitting diode (LED), a field emission display (FED), and so on.

The communication device 22 may be a signal transmission component that supports global system for mobile communication (GSM), personal handy-phone system (PHS), code division multiple access (CDMA) system, wideband code division multiple access (WCDMA) system, long term evolution (LTE) system, worldwide interoperability for microwave access (WiMAX) system, wireless fidelity (Wi-Fi) system, or Bluetooth.

The storage device 24 may be any type of fixed or portable random access memory (RAM), read-only memory (ROM), flash memory, similar devices, or a combination of the foregoing.

The processing device 26 may be a central processing unit (CPU), a programmable microprocessor for general or special purposes, a digital signal processor (DSP), a programmable controller, an application specific integrated circuit (ASIC), other similar devices, or a combination of the foregoing.

In this exemplary embodiment, the storage device 24 of the electronic device 100 stores a plurality of code snippets therein, which are executed by the processing device 26 after being installed. For example, the storage device 24 includes a plurality of modules for respectively executing operations that the electronic device 100 applies in the user location notification system 1000, wherein each of the modules is composed of one or more code snippets. Nevertheless, the invention is not limited thereto. Each operation of the electronic device 100 may also be implemented in other hardware forms.

FIG. 2B is a schematic diagram of the server according to an embodiment of the invention.

Referring to FIG. 2B, the server 110 includes a communication device 30, a storage device 32, and a processing device 34. The communication device 30 and the storage device 32 are respectively coupled to the processing device 34. The communication device 30, the storage device 32, and the processing device 34 may be components similar to the communication device 22, the storage device 24, and the processing device 26 respectively and thus details thereof are not repeated hereinafter.

In this exemplary embodiment, the storage device 32 of the server 110 stores a plurality of code snippets therein, which are executed by the processing device 34 after being installed. For example, the storage device 32 includes a plurality of modules for respectively executing operations that the server 110 applies in the user location notification system 1000, wherein each of the modules is composed of one or more code snippets. Nevertheless, the invention is not limited thereto. Each operation of the server 110 may also be implemented in other hardware forms.

FIG. 2C is a schematic diagram of the signal transmitting device according to an embodiment of the invention.

Referring to FIG. 2C, the signal transmitting device 130 includes a signal transmitter 40 and a processing device 42. The signal transmitter 40 is coupled to the processing device 42. The processing device 42 may be a component similar to the processing device 26 and thus details thereof are not repeated hereinafter.

The signal transmitter 40 is a transmitter for transmitting signals, and a signal transmitted by the transmitter may include an identification code, which is for identifying an identity of a user holding the signal transmitting device 130, for example. In this exemplary embodiment, the signal transmitter 40 is for transmitting a beacon. Nevertheless, the invention is not limited thereto. The signal transmitter 40 may also transmit other types of signals.

FIG. 2D is a schematic diagram of the sensing device according to an embodiment of the invention. It should be noted that since the sensing devices 140 to 144 in FIG. 1 are substantially similar to one another, only the sensing device 240 is described hereinafter to explain the components required by these sensing devices.

Referring to FIG. 2D, the sensing device 240 includes a signal receiving device 50, a communication device 52, and a processing device 54. The signal receiving device 50 and the communication device 52 are coupled to the processing device 54. The communication device 52 and the processing device 54 may be components similar to the communication device 22 and the processing device 26 respectively and thus details thereof are not repeated hereinafter.

The signal receiving device 50 is configured to receive (or sense) the signal transmitted by the signal transmitter 40 of the signal transmitting device 130. In this exemplary embodiment, the signal receiving device 50 is a signal receiver for receiving the beacon, and the signal receiver is a Bluetooth Low Energy (BLE) bridge, for example, for combining functions of BLE detection and Wi-Fi communication. Nevertheless, the invention is not limited thereto. The signal receiving device 50 may also be a signal receiver that receives (or senses) other types of signals.

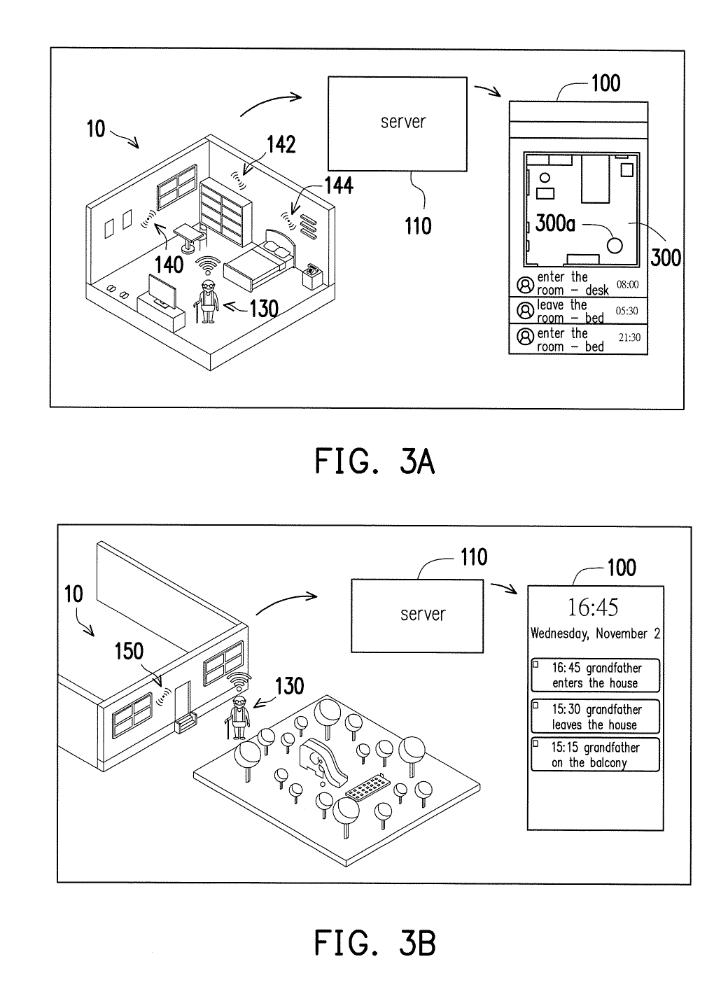

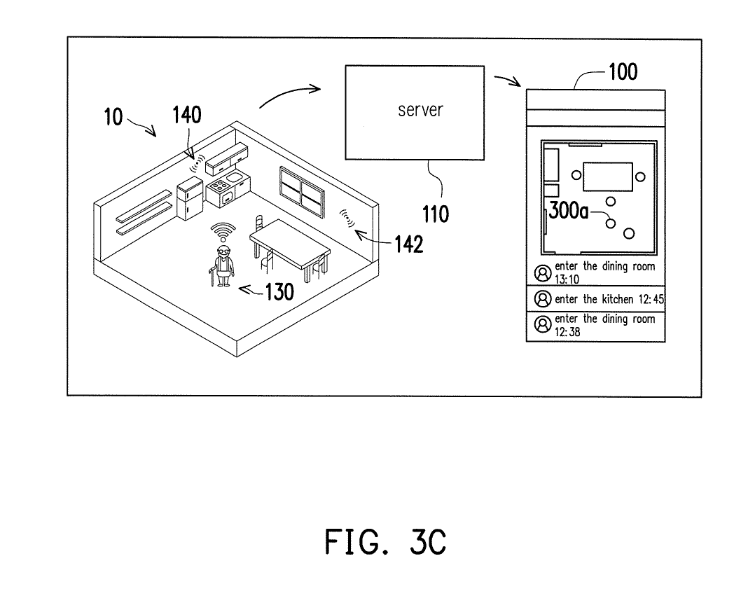

FIG. 3A is a schematic diagram of application of the user location notification system according to an embodiment of the invention.

Referring to FIG. 1 and FIG. 3A, in the embodiment of FIG. 3A, the sensing device 140, the sensing device 142, and the sensing device 144 are disposed at different locations in the place 10 respectively. In the embodiment of FIG. 3A, the place 10 is an indoor room. The signal transmitting device 130 is worn by an elderly person who is being monitored. The signal transmitting device 130 successively transmits a signal (also referred to as first signal) related to the monitored elderly person. The first signal may include an identification code, and the server may store a user record therein. The user record includes a corresponding relationship between the identification code in the first signal and the elderly person who wears the signal transmitting device 130. The corresponding relationship is a corresponding relationship between the identification code in the first signal and a name of the elderly person, for example, but not limited thereto.

In the embodiment of FIG. 3A, the sensing device 140, the sensing device 142, and the sensing device 144 in the place 10 may respectively (and successively) detect the signal transmitted by the signal transmitting device 130. When the sensing device 140 detects the signal transmitted by the signal transmitting device 130, the sensing device 140 transmits a message (also referred to as first message) to the server 110 according to the signal. The first message may include the identification code in the first signal, signal intensity of the first signal detected by the sensing device 140, or other information, for example, but not limited thereto. In particular, the first message is used for the server 110 to determine a current location of the signal transmitting device 130 in the sensing range of the sensing device 140 and/or a distance between the signal transmitting device 130 and the sensing device 140.

Likewise, when the sensing device 142 detects the signal transmitted by the signal transmitting device 130, the sensing device 142 transmits a message (also referred to as second message) to the server 110 according to the signal. The second message may include the identification code in the first signal, signal intensity of the first signal detected by the sensing device 142, or other information, for example, but not limited thereto. In particular, the second message is used for the server 110 to determine a current location of the signal transmitting device 130 in the sensing range of the sensing device 142 and/or a distance between the signal transmitting device 130 and the sensing device 142.

Likewise, when the sensing device 144 detects the signal transmitted by the signal transmitting device 130, the sensing device 142 transmits a message (also referred to as third message) to the server 110 according to the signal. The third message may include the identification code in the first signal, signal intensity of the first signal detected by the sensing device 144, or other information, for example, but not limited thereto. In particular, the third message is used for the server 110 to determine a current location of the signal transmitting device 130 in the sensing range of the sensing device 144 and/or a distance between the signal transmitting device 130 and the sensing device 144.

In particular, the server 110 further stores a place record (also referred to as first place record). The first place record includes a first location of the sensing device 140 in the place 10, a second location of the sensing device 142 in the place 10, and a third location of the sensing device 144 in the place 10. When the server 110 receives the first message, the second message, and the third message respectively transmitted by the sensing device 140, the sensing device 142, and the sensing device 144, the server 110 determines (or acquires) a specific location of the user who wears the signal transmitting device 130 in the place 10 according to the first place record, the first message, the second message, the third message, and a triangulation algorithm. Then, the server 110 may transmit a notification message (also referred to as first notification message) that indicates the specific location of the user in the place 10 to the electronic device 100.

For example, the electronic device 100 displays a floor plan 300 of the place 10 according to the first notification message. The floor plan 300 includes an item 300a that is for indicating the specific location of the elderly person who wears the signal transmitting device 130 in the place 10. In particular, as the elderly person who wears the signal transmitting device 130 moves in the place 10, the sensing device 140, the sensing device 142, and the sensing device 144 successively detect the signal transmitted by the signal transmitting device 130. The sensing device 140, the sensing device 142, and the sensing device 144 may successively transmit the messages to the server 110 according to the detected signal. The server 110 may receive the messages to instantly determine and transmit the message back to the electronic device 100. Therefore, as the elderly person who wears the signal transmitting device 130 moves in the place 10, the item 300a also moves instantly in the floor plan 300 to indicate the current location of the elderly person who wears the signal transmitting device 130.

Moreover, in an exemplary embodiment, the server 110 may also determine whether the elderly person who wears the signal transmitting device 130 leaves or enters the place 10 according to the first message, the second message, and the third message. For example, it is assumed that the sensing device 140, the sensing device 142, and the sensing device 144 do not sense the signal transmitted by the signal transmitting device 130 in an initial state, and when the sensing device 140, the sensing device 142, and the sensing device 144 respectively sense the signal transmitted by the signal transmitting device 130, they may transmit the first message, the second message, and the third message to the server 110 for the server 110 to instantly determine the location of the elderly person who wears the signal transmitting device 130 in the place 10 and determine that the elderly person who wears the signal transmitting device 130 has entered the room. At this time, the server 110 may further transmit a notification message to the electronic device 100. This notification message indicates that the elderly person who wears the signal transmitting device 130 has entered the place 10.

Then, it is assumed that when the sensing device 140, the sensing device 142, and the sensing device 144 do not sense the signal transmitted by the signal transmitting device 130, they may respectively transmit the messages to the server 110 for the server 110 to instantly determine that the elderly person who wears the signal transmitting device 130 has left the place 10. At this time, the server 110 may further transmit a notification message to the electronic device 100. This notification message indicates that the elderly person who wears the signal transmitting device 130 has left the place 10.

Based on the above, when the electronic device 100 receives the notification message, the electronic device 100 may display a push message according to the notification message, wherein the push message indicates that the elderly person who wears the signal transmitting device 130 has left or entered the place 10.

Moreover, in an embodiment, a sensing device may be disposed around an entrance/exit (i.e., door) of the place 10 to detect the signal of the signal transmitting device 130 and transmit the message back to the server 110 according to the detected signal. The server 110 may determine whether the elderly person who wears the signal transmitting device 130 has left or enters the place 10 according to the signal transmitted by the sensing device disposed around the entrance/exit of the place 10, and transmit the second message to the electronic device 100.

For example, FIG. 3B is a schematic diagram showing detection of the user wearing the signal transmitting device who enters or leaves a place according to an embodiment of the invention.

Referring to FIG. 3B, a sensing device 150 (also referred to as fourth sensing device) is the sensing device as shown in FIG. 2D, for example. The sensing device 150 is disposed near the entrance/exit of the place 10 for detecting the signal of the signal transmitting device 130. It is assumed that the sensing device 150 does not sense the signal transmitted by the signal transmitting device 130 in an initial state, and when the sensing device 150 senses the signal transmitted by the signal transmitting device 130, the sensing device 150 may successively transmit a message (also referred to as fourth message) to the server 110 according to the sensed signal. For example, the server 110 may instantly determine that the elderly person who wears the signal transmitting device 130 is moving closer to the sensing device 150 according to the fourth message, so as to determine that the elderly person who wears the signal transmitting device 130 enters the room. At this time, the server 110 may transmit a notification message (also referred to as third notification message) to the electronic device 100 to indicate that the elderly person who wears the signal transmitting device 130 enters the place 10. When the electronic device 100 receives the notification message, the electronic device 100 may display a message regarding that the elderly person who wears the signal transmitting device 130 enters the place 10 by push.

Likewise, it is assumed that when the server 110 determines that the elderly person who wears the signal transmitting device 130 is moving away from the sensing device 150 according to the fourth message transmitted by the sensing device 150, the server 110 may determine that the elderly person who wears the signal transmitting device 130 leaves the place 10. At this time, the server 110 may transmit a notification message (also referred to as third notification message) to the electronic device 100 to indicate that the elderly person who wears the signal transmitting device 130 has left the place 10. When the electronic device 100 receives the notification message, the electronic device 100 may display a message regarding that the elderly person who wears the signal transmitting device 130 has left the place 10 by push.

It should be noted that, in FIG. 3A, three sensing devices and one server are used to determine the location of the elderly person who wears the signal transmitting device 130 in the place 10 and determine whether the elderly person who wears the signal transmitting device 130 has left the place 10. In an embodiment, however, two sensing devices and one server may be used to determine the location of the elderly person who wears the signal transmitting device 130 in the place 10 and determine whether the elderly person who wears the signal transmitting device 130 has left the place 10.

FIG. 3C is a schematic diagram of application of the user location notification system according to another embodiment of the invention.

In the embodiment of FIG. 3C, the sensing device 140 and the sensing device 142 are disposed at different locations in the place 10 respectively. In the embodiment of FIG. 3C, the place 10 is an indoor room. The signal transmitting device 130 is worn by an elderly person who is being monitored. The signal transmitting device 130 successively transmits a signal (also referred to as first signal) related to the monitored elderly person. The sensing device 140 and the sensing device 142 in the place 10 may respectively and successively detect the signal transmitted by the signal transmitting device 130. When the sensing device 140 detects the signal transmitted by the signal transmitting device 130, the sensing device 140 transmits a message (also referred to as first message) to the server according to the signal. The content of the first message has been specified above and thus details thereof are not repeated hereinafter.

Likewise, when the sensing device 142 detects the signal transmitted by the signal transmitting device 130, the sensing device 142 transmits a message (also referred to as second message) to the server according to the signal. The content of the second message has been specified above and thus details thereof are not repeated hereinafter.

In particular, the server 110 further stores a place record (also referred to as first place record). The first place record includes a first location of the sensing device 140 in the place 10 and a second location of the sensing device 142 in the place 10. When the server 110 receives the first message and the second message respectively transmitted by the sensing device 140 and the sensing device 142, the server 110 determines (or acquires) a specific location of the user who wears the signal transmitting device 130 in the place 10 according to the first place record, the first message, and the second message. For example, the server 110 may determine a corresponding relationship between the locations of the signal transmitting device 130 and the sensing device 140 according to the first message and a corresponding relationship between the locations of the signal transmitting device 130 and the sensing device 142 according to the second message, and calculate the current location of the signal transmitting device 130 in the place 10 according to the corresponding relationships, the first location, and the second location. Then, the server 110 may transmit a notification message (also referred to as first notification message) that indicates the specific location of the user in the place 10 to the electronic device 100. Similar to the above, the electronic device 100 displays the floor plan 300 of the place 10 according to the first notification message. The floor plan 300 includes an item 300a for indicating the current specific location of the elderly person who wears the signal transmitting device 130 in the place 10.

Moreover, in an exemplary embodiment, the server 110 may also determine whether the elderly person who wears the signal transmitting device 130 leaves or enters the place 10 according to the first message and the second message. For example, it is assumed that the sensing device 140 and the sensing device 142 do not sense the signal transmitted by the signal transmitting device 130 in an initial state, and when the sensing device 140 and the sensing device 142 respectively sense the signal transmitted by the signal transmitting device 130, they may transmit the first message and the second message to the server 110 for the server 110 to instantly determine the location of the elderly person who wears the signal transmitting device 130 in the place 10 and determine that the elderly person who wears the signal transmitting device 130 has entered the room. At this time, the server 110 may further transmit a notification message (also referred to as second notification message) to the electronic device 100. This notification message indicates that the elderly person who wears the signal transmitting device 130 has entered the place 10.

Then, it is assumed that when the sensing device 140 and the sensing device 142 do not sense the signal transmitted by the signal transmitting device 130, the sensing device 140 and the sensing device 142 may respectively transmit the messages to the server 110. The server 110 may instantly determine that the elderly person who wears the signal transmitting device 130 has left the place 10. At this time, the server 110 may transmit a notification message to the electronic device 100. This notification message indicates that the elderly person who wears the signal transmitting device 130 has left the place 10.

Based on the above, when the electronic device 100 receives the notification message, the electronic device 100 may display a push message according to the notification message, wherein the push message indicates that the elderly person who wears the signal transmitting device 130 has left or entered the place 10.

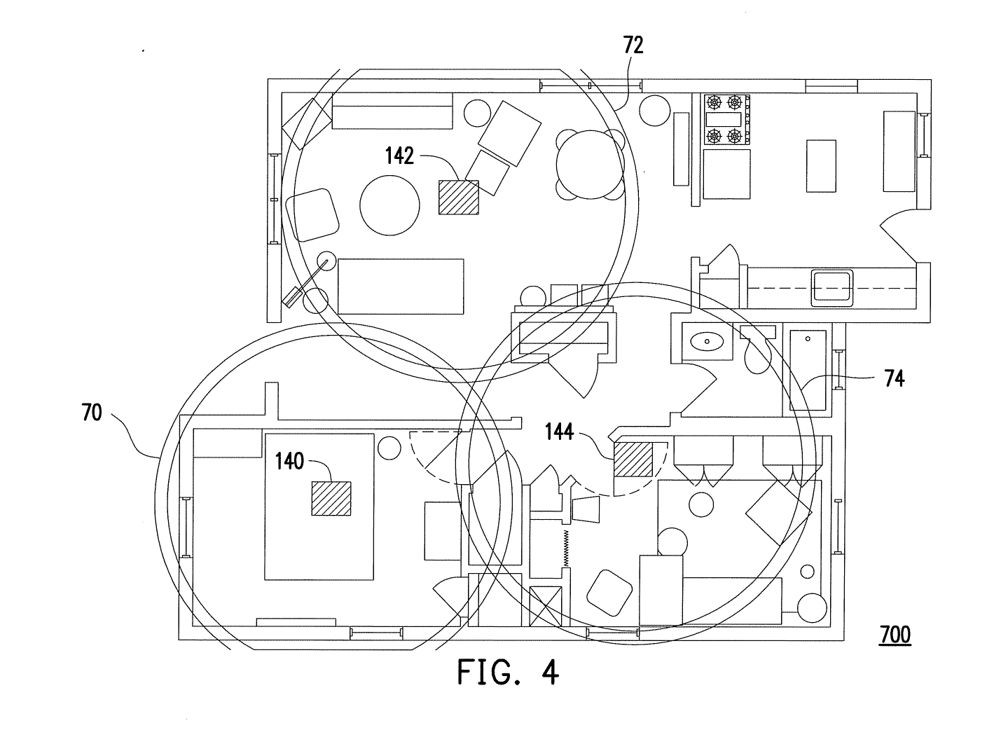

FIG. 4 is a schematic diagram of configuration of the sensing devices according to an embodiment of the invention.

Referring to FIG. 4, it is assumed that a floor plan 700 is the floor plan of the place 10. The user may decide the optimal locations of the sensing device 140, the sensing device 142, and the sensing device 144 according to a sensing range 70 of the sensing device 140, a sensing range 72 of the sensing device 142, and a sensing range 74 of the sensing device 144. For example, the user may dispose the sensing devices such that the sensing range 70, the sensing range 72, and the sensing range 74 cover the entire place 10 as much as possible. It should be noted that, when the signal transmitting device 130 is within the sensing range of one sensing device, the sensing device may detect the signal transmitted by the signal transmitting device 130, so as to transmit a message to the server 110 according to the signal for determining the location. When the signal transmitting device 130 is in an overlap area of the sensing ranges of two sensing devices, both the sensing devices may detect the signal transmitted by the signal transmitting device 130, so as to respectively transmit messages to the server 110 according to the signal for determining the location. When the signal transmitting device 130 is in the overlap area of the sensing ranges of three sensing devices, all the three sensing devices may detect the signal transmitted by the signal transmitting device 130, so as to respectively transmit messages to the server 110 according to the signal for determining the location.

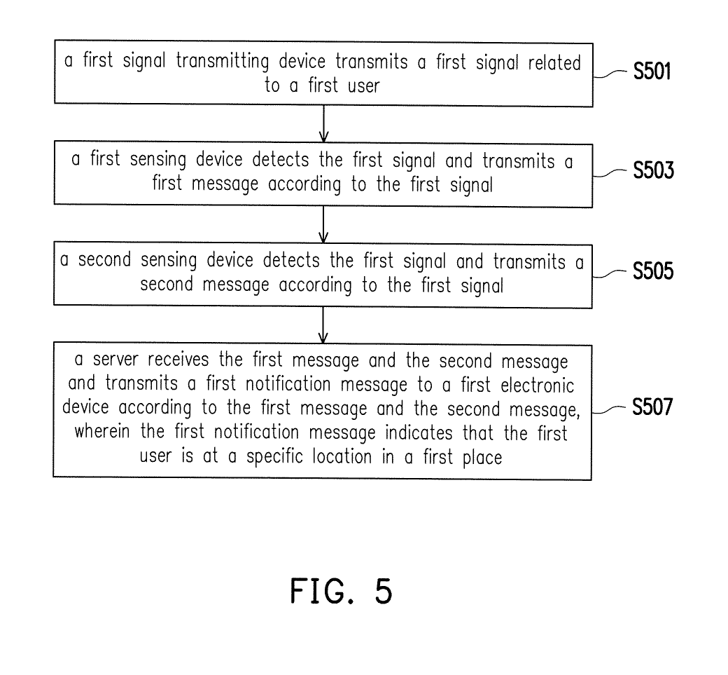

FIG. 5 is a flowchart of a user location notification method according to an embodiment of the invention.

Referring to FIG. 5, in Step S501, a first signal transmitting device transmits a first signal related to a first user. In Step S503, a first sensing device detects the first signal and transmits a first message according to the first signal. In Step S505, a second sensing device detects the first signal and transmits a second message according to the first signal. In Step S507, a server receives the first message and the second message and transmits a first notification message to a first electronic device according to the first message and the second message, wherein the first notification message indicates that the first user is at a specific location in a first place.

To sum up, the user location notification system and the user location notification method provided by the invention make it possible to effectively position the user that is being monitored (e.g., the elderly) indoors and instantly transmit the message indicating the specific location of the monitored user in the indoor space back to the electronic device of another user (e.g., children or social workers). Thus, the system is capable of achieving accurate positioning and real-time monitoring.

It will be apparent to those skilled in the art that various modifications and variations can be made to the disclosed embodiments without departing from the scope or spirit of the invention. In view of the foregoing, it is intended that the invention covers modifications and variations provided that they fall within the scope of the following claims and their equivalents.

What is claimed is:

1. A user location notification system, comprising:
a first signal transmitting device transmitting a first signal related to a first user;
a first sensing device disposed in a first place and detecting the first signal and transmitting a first message according to the first signal;
a second sensing device disposed in the first place and detecting the first signal and transmitting a second message according to the first signal; and
a server receiving the first message and the second message and transmitting a first notification message to a first electronic device according to the first message and the second message, wherein the first notification message indicates that the first user is at a specific location in the first place.

2. The user location notification system according to claim 1, further comprising:
a third sensing device disposed in the first place and detecting the first signal and transmitting a third message according to the first signal,
wherein when receiving the first message and the second message and transmitting the first notification message to the first electronic device according to the first message and the second message,
the server receives the first message, the second message, and the third message and acquires the specific location of the first user in the first place according to the first message, the second message, the third message, and a triangulation algorithm.

3. The user location notification system according to claim 2, wherein:
the server stores a first place record, which comprises a first location of the first sensing device in the first place, a second location of the second sensing device in the first place, and a third location of the third sensing device in the first place.

4. The user location notification system according to claim 3, wherein:
when acquiring the specific location of the first user in the first place according to the first message, the second message, the third message, and the triangulation algorithm,
the server acquires the specific location of the first user in the first place according to the first place record, the first message, the second message, the third message, and the triangulation algorithm.

5. The user location notification system according to claim 1, wherein:
the first electronic device displays a floor plan of the first place according to the first notification message, and the floor plan comprises an item that indicates the specific location of the first user in the first place.

6. The user location notification system according to claim 1, wherein:
the server determines whether the first user leaves or enters the first place according to the first message and the second message, and
when the server determines that the first user leaves or enters the first place according to the first message and the second message, the server transmits a second notification message to the first electronic device, wherein the second notification message indicates that the first user leaves or enters the first place.

7. The user location notification system according to claim 6, wherein:
the first electronic device displays a push message according to the second notification message, wherein the push message indicates that the first user leaves or enters the first place.

8. The user location notification system according to claim 1, further comprising:
a fourth sensing device disposed near an entrance/exit of the first place and detecting the first signal and transmitting a fourth message according to the first signal,
wherein the server receives the fourth message and determines whether the first user leaves or enters the first place according to the fourth message, and
when the server determines that the first user leaves or enters the first place according to the fourth message, the server transmits a third notification message to the first electronic device, wherein the third notification message indicates that the first user leaves or enters the first place.

9. The user location notification system according to claim 1, wherein the first signal related to the first user is a Beacon signal.

10. The user location notification system according to claim 1, wherein each of the first sensing device and the second sensing device is a Bluetooth Low Energy (BLE) bridge.

11. A user location notification method, adapted for a user location notification system that comprises a first signal transmitting device, a first sensing device, a second sensing device, and a server, wherein the first sensing device and the second sensing device are disposed in a first place, the user location notification method comprising:
transmitting a first signal related to a first user by the first signal transmitting device;
detecting the first signal and transmitting a first message according to the first signal by the first sensing device;
detecting the first signal and transmitting a second message according to the first signal by the second sensing device; and
receiving the first message and the second message and transmitting a first notification message to a first electronic device according to the first message and the second message by the server,
wherein the first notification message indicates that the first user is at a specific location in the first place.

12. The user location notification method according to claim 11, wherein the user location notification system further comprises a third sensing device disposed in the first place, and the user location notification method further comprises:
detecting the first signal and transmitting a third message according to the first signal by the third sensing device,
wherein receiving the first message and the second message and transmitting the first notification message to the first electronic device according to the first message and the second message comprises:
receiving the first message, the second message, and the third message and acquiring the specific location of the first user in the first place according to the first message, the second message, the third message, and a triangulation algorithm by the server.

13. The user location notification method according to claim 12, further comprising:
storing a first place record by the server, wherein the first place record comprises a first location of the first sensing device in the first place, a second location of the second sensing device in the first place, and a third location of the third sensing device in the first place.

14. The user location notification method according to claim 13, wherein acquiring the specific location of the first user in the first place according to the first message, the second message, the third message, and the triangulation algorithm comprises:
acquiring the specific location of the first user in the first place according to the first place record, the first message, the second message, the third message, and the triangulation algorithm by the server.

15. The user location notification method according to claim 11, further comprising:
displaying a floor plan of the first place according to the first notification message by the first electronic device, wherein the floor plan comprises an item that indicates the specific location of the first user in the first place.

16. The user location notification method according to claim 11, further comprising:
determining whether the first user leaves or enters the first place according to the first message and the second message by the server; and
transmitting a second notification message to the first electronic device by the server when the server determines that the first user leaves or enters the first place according to the first message and the second message, wherein the second notification message indicates that the first user leaves or enters the first place.

17. The user location notification method according to claim 16, further comprising:
displaying a push message according to the second notification message by the first electronic device, wherein the push message indicates that the first user leaves or enters the first place.

18. The user location notification method according to claim 11, wherein the user location notification system further comprises a fourth sensing device disposed near an entrance/exit of the first place, and the user location notification method further comprises:
detecting the first signal and transmitting a fourth message according to the first signal by the fourth sensing device;
receiving the fourth message and determining whether the first user leaves or enters the first place according to the fourth message by the server; and
transmitting a third notification message to the first electronic device by the server when the server determines that the first user leaves or enters the first place according to the fourth message, wherein the third notification message indicates that the first user leaves or enters the first place.

19. The user location notification method according to claim 11, wherein the first signal related to the first user is a Beacon signal.

20. The user location notification method according to claim 11, wherein each of the first sensing device and the second sensing device is a Bluetooth Low Energy (BLE) bridge.
